(19) United States
(12) Patent Application Publication
(10) Pub. No.: US 2002/0054675 A1
(43) Pub. Date: May 9, 2002

(54) Apparatus for screening telephone calls

(76) Inventor: Frank Brooks, Philadelphia, PA (US)

Correspondence Address: Matthew J. Peirce, Esq., 1550 Starlight Canyon Avenue, Las Vegas, NV, 89123, US

(21) Appl. No.: 10/008,668

(22) Filed: Nov. 3, 2001

Related U.S. Application Data
(60) Provisional application No. 60/246,057, filed on Nov. 6, 2000.

(51) Int. Cl. H04M 3/42

(52) U.S. Cl. 379/210.02

(57) ABSTRACT

A new and improved apparatus is disclosed for screening telephone calls. The apparatus would be a device which would be electronically connected to a phone line in between a telephone and a wall jack. The apparatus would have a programmable numerical key pad and also would have a top-mounted speaker. The apparatus would serve as an interceptor of telephone calls. Once another person would call a person who had the present invention, the other person would have to enter a 2/3 code within ten to twelve seconds, or they would be cut off. If the other person entered the correct code, the present invention would play an eternal melody note that would indicate a welcome call.

### I. BACKGROUND OF THE INVENTION

The present invention concerns that of a new and improved apparatus for screening telephone calls.

### II. DESCRIPTION OF THE PRIOR ART

U.S. Pat. No. 5,901,209, issued to Tannenbaum et al., discloses a system and method for selectively adjusting the caller identification of a calling party based, in part, on parameters associated with adjusting the calling party.

U.S. Pat. No. 5,864,612, issued to Strauss et al., discloses an advanced intelligent network that is used to allow a calling party to specific what caller ID information to send to the called party for display.

U.S. Pat. No. 5,031,205, issued to Phillips, discloses an auto response phone system which is provided that allows a user to automatically screen calls and respond without even talking into a telephone receiver.

U.S. Pat. No. 4,893,329, issued to O'Brien, discloses a telephone call deferral system which allows incoming telephone calls to be deferred for a user selected period or until a user selected time.

### III. SUMMARY OF THE INVENTION

The present invention concerns that of a new and improved apparatus for screening telephone calls. The apparatus would be a device which would be electronically connected to a phone line in between a telephone and a wall jack. The apparatus would have a programmable numerical key pad and also would have a top mounted speaker. The apparatus would serve as an interceptor of telephone calls. Once another person would call a person who had the present invention, the other person would have to enter a 2/3 code within ten to twelve seconds, or they would be cut off. If the other person entered the correct code, the present invention would play an eternal melody note that would indicate a welcome call.

There has thus been outlined, rather broadly, the more important features of an apparatus for screening telephone calls in order that the detailed description thereof that follows may be better understood and in order that the present contribution to the art may be better appreciated. There are, of course, additional features of the apparatus for screening telephone calls that will be described hereinafter and which will form the subject matter of the claims appended hereto.

In this respect, before explaining at least one embodiment of the apparatus for screening telephone calls in detail, it is to be understood that the apparatus for screening telephone calls is not limited in its application to the details of construction and to the arrangements of the components set forth in the following description or illustrated in the drawings. The apparatus for screening telephone calls is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present apparatus for screening telephone calls. It is important, therefore, that the claims be regard as including such equivalent constructions insofar as they do not depart from the spirit and scope of the present invention.

It is therefore an object of the present invention to provide an apparatus for screening telephone calls which has all of the advantages of the prior art and none of the disadvantages.

It is another object of the present invention to provide an apparatus for screening telephone calls which may be easily and efficiently manufactured and marketed.

It is another object of the present invention to provide an apparatus for screening telephone calls which is of durable and reliable construction.

It is yet another object of the present invention to provide an apparatus for screening telephone calls which is economically affordable and available for the buying public.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows the present invention configured to that of a telephone line and a standard telephone.

### V. DESCRIPTION OF THE PREFERRED EMBODIMENT

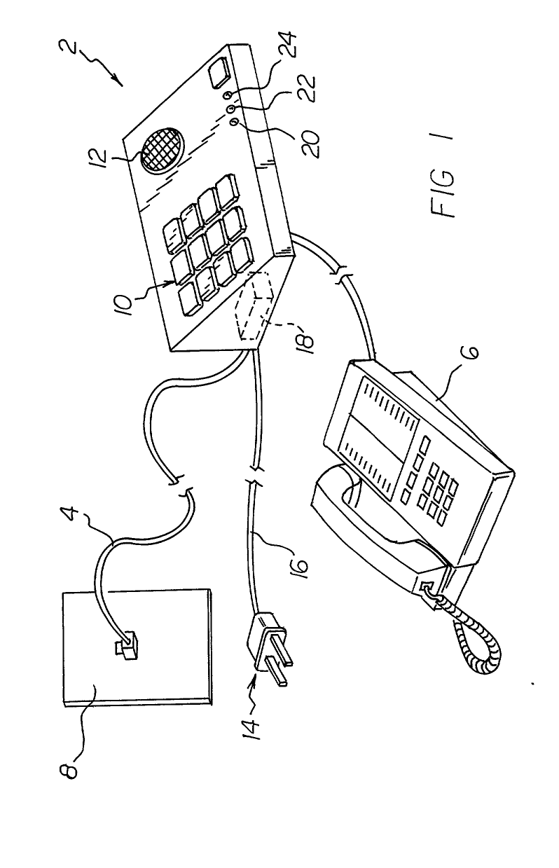

FIG. 1 shows the present invention configured to that of a telephone line 4 and a standard telephone 6. The present invention serves as an interceptor, and thus will be referred to as fone plus 2. Fone plus 2 concerns that of a new and improved apparatus for screening telephone calls and would be electronically connected to a telephone line 4 in between a telephone 6 and a wall jack 8. Fone plus 2 would have an outer casing and would also have a programmable numerical key pad 10 and a top-mounted speaker 12. Fone plus 2 would serve to intercept incoming telephone calls.

Once an incoming caller would call a residence that had fone plus 2 installed, the incoming caller would have to enter a 2/3 code within ten to twelve seconds, or their incoming phone call would be terminated. If the incoming caller entered the correct code, the present invention would play an eternal melody note that would indicate a welcome call. The person with the present invention would then have the option of picking up the phone or letting voice mail or an answering machine answer the incoming call.

Fone plus 2 would also have power means 14, which preferably would be a power cord 16. Alternatively, fone plus 2 could be powered by a battery 18 which would be located within fone plus 2. In addition, fone plus 2 would have a plurality of indicator lights to indicate various items. Indicator light 20 would be yellow and would indicate that the unit would be on. Indicator light 22 would be red and would indicate if an incoming call had been attempted. Indicator light 24 would be green and would indicate if an incoming call had been completed.

The present invention could also be designed to have internal melody sounds.

What I claim as my invention is:

1. A system for screening telephone calls comprising:
(a) an interceptor unit, the interceptor unit having an outer casing, the the interceptor unit also having an input jack for receiving a first telephone line, the interceptor unit also having an output jack for connecting to a second telephone line,
(b) a telephone wall jack,
(c) a first telephone line having two ends, a first end and a second end, the first end of the first telephone line hooked up to the telephone wall jack, the second end of the first telephone line hooked up to the input jack on the interceptor unit,
(d) a telephone,
(e) a second telephone line having two ends, a first end and a second end, the first end of the second telephone line hooked up to the output jack on the interceptor unit, the second end of the second telephone line hooked up to the telephone,
(f) a speaker attached to the interceptor unit,
(g) a programmable numerical keypad attached to the top of the interceptor unit,
(h) power means to provide power to the interceptor unit,
(i) a plurality of indicator lights located on the outer casing of the interceptor unit,
(j) wherein when an individual would place an incoming phone call to a residence that would have system installed, the interceptor unit would intercept the phone call and require the individual to enter a numerical code within a specified period of time, and further wherein the interceptor unit would terminate the incoming phone call if the numerical call had not been entered within the specified period of time, and further wherein the speaker on the interceptor unit would play an eternal melody note that would indicate a welcome call if the individual entered the numerical code within the specified period of time, and further wherein the telephone call would be passed on to the telephone.

2. A system for screening telephone calls according to claim 1 wherein the plurality of indicator lights would further comprise a red light, a yellow light, and a green light.

3. A system for screening telephone calls according to claim 2 wherein the red light would indicate whether an incoming call had recently been attempted.

4. A system for screening telephone calls according to claim 2 wherein the yellow light would indicate whether the interceptor unit was on.

5. A system for screening telephone calls according to claim 2 wherein the green light would indicate whether an incoming call had been completed.

6. A system for screening telephone calls according to claim 2 wherein the power means would be standard household current.

7. A system for screening telephone calls according to claim 2 wherein the power means would be a battery incorporated within the interceptor unit.

8. A method for screening incoming telephone calls comprising the steps of:
(a) electronically connecting a screening mechanism in between a wall jack and a telephone,
(b) programming the screening mechanism to filter each incoming calls by requiring each incoming callers to input a numerical code within a specified time frame after the screening mechanism picks up each incoming call,
(c) disconnecting an incoming call if the user making the incoming call does not input the required numerical code within the specified time frame, and
(d) permitting the incoming call to be passed on to the telephone if the user making the incoming call inputs the required numerical code within the specified time frame.

9. A method for screening incoming telephone calls according to claim 8 wherein the numerical code would be a 2/3 code.

10. A method for screening incoming telephone calls according to claim 8 wherein the specified time frame would preferably be between ten to twelve seconds.
